(19) United States
(12) Patent Application Publication
(10) Pub. No.: US 2014/0206376 A1
(43) Pub. Date: Jul. 24, 2014

(54) RADIO COMMUNICATION SYSTEM, RADIO BASE STATION, AND RADIO COMMUNICATION METHOD

(71) Applicant: Naohisa Matsumoto, Kawasaki-shi (JP)

(72) Inventor: Naohisa Matsumoto, Kawasaki-shi (JP)

(73) Assignee: KYOCERA CORPORATION, Kyoto (JP)

(21) Appl. No.: 14/235,230

(22) PCT Filed: Jul. 24, 2012
(86) PCT No.: PCT/JP2012/004710

§ 371 Date: Jan. 27, 2014

(30) Foreign Application Priority Data
Jul. 27, 2011 (JP) 2011-164827

(51) Int. Cl. H04W 72/04; H04W 72/08

(52) U.S. Cl. CPC H04W 72/0406; H04W 72/08
USPC 455/452.2; 455/450

(57) ABSTRACT

The disclosed radio communication system can improve the transmission quality of control information. When the number of connections by a radio terminal to the radio base station is less than a predetermined value, a base station control unit (12) allocates more than one uplink control channel element to a radio terminal (2).

### CROSS-REFERENCE TO RELATED APPLICATION

This application claims priority to and the benefit of Japanese Patent Application No. 2011-164827 filed Jul. 27, 2011, the entire contents of which are incorporated herein by reference.

### TECHNICAL FIELD

The present invention relates to a radio communication system, a radio base station, and a radio communication method.

### BACKGROUND

A radio terminal using LTE transmits control information to a radio base station over an uplink control channel (PUCCH: Physical Uplink Control Channel). According to LTE specifications, the resource block in the uplink is used for the uplink control channel (Non-patent Literature 1).

The uplink control channel includes “format 1” for transmitting the HARQ ACK/NACK of the downlink signal and an uplink scheduling request, and “format 2” for transmitting quality information about the downlink. As illustrated in FIG. 7, with “format 1”, the resources of the uplink control channel are divided into 36 parts by the value of the cyclic shift (referred to below as “CS”) and the orthogonal cover sequences (referred to below as “OC”). In greater detail, in FIG. 7 the vertical axis is the CS, which has 12 different values. The horizontal axis is the OC, which has three different values. Combinations of the CS and the OC specify 36 uplink control channel elements. Below, each element of the 36 divided resources is referred to as an “uplink control channel element”. Since any particular uplink control channel element is specified by a combination of the CS and the OC, such a CS and OC combination is referred to as the “address of an uplink control channel element”.

Control information for each radio terminal is stored in one uplink control channel element. In FIG. 7, control information for a certain radio terminal is stored in uplink control channel element 200, and control information for another radio terminal is stored in uplink control channel element 300.

In the case of “format 2”, the CS has 12 different values, and the OC has one value, yielding 12 divisions. Like “format 1”, with “format 2” control information for each radio terminal is stored in one uplink control channel element.

### CITATION LIST

Non-patent Literature 1: Japanese translation of E. Dahlman et al., “3G Evolution Second Edition HSPA and LTE for Mobile Broadband”, by T. Hattori, T. Morohashi, and M. Fujioka. Maruzen, 2009, p. 438.

### SUMMARY

In a radio communication system provided with the above radio terminal and radio base station, there is a desire for improvement in the transmission quality of the control information transmitted by the radio terminal to the radio base station.

Accordingly, the present invention has been conceived in light of the above considerations and provides a radio communication system that can improve the transmission quality of control information.

In order to solve the above problems, a radio communication system according to the present invention includes a radio base station and a radio terminal. The radio base station includes a base station transceiver unit configured to receive a radio signal, and a base station control unit configured to allocate any of a plurality of uplink control channel elements included in an uplink control channel to the radio terminal. When a number of connections by the radio terminal to the radio base station is less than a predetermined value, the base station control unit allocates more than one of the uplink control channel elements to the radio terminal.

In the radio communication system according to the present invention, the base station control unit may acquire a reception quality of the radio terminal, and when the reception quality is less than a first threshold, may allocate more than one of the uplink control channel elements to the radio terminal.

In the radio communication system according to the present invention, the radio terminal may include a terminal transceiver unit configured to receive a radio signal, and a terminal control unit configured to execute control so as to transmit control information over each uplink control channel element allocated based on an instruction from the radio base station.

In the radio communication system according to the present invention, when a reception quality of a radio signal transmitted by the radio base station is a second threshold or less, the terminal control unit may issue a request to the radio base station for allocation of more than one of the uplink control channel elements.

In the radio communication system according to the present invention, the radio terminal may transmit identical control information over the more than one uplink control channel elements.

In the radio communication system according to the present invention, the radio terminal may transmit different control information over the more than one uplink control channel elements.

A radio base station according to the present invention includes a base station transceiver unit configured to receive a radio signal, and a base station control unit configured to allocate any of a plurality of uplink control channel elements included in an uplink control channel to a radio terminal. When a number of connections by the radio terminal to the radio base station is less than a predetermined value, the base station control unit allocates more than one of the uplink control channel elements to the radio terminal.

A method for radio communication according to the present invention includes a radio base station and a radio terminal, the method including: receiving, by the radio base station, a radio signal from the radio terminal; and allocating, by the radio base station, any of a plurality of uplink control channel elements included in an uplink control channel to the radio terminal. In the allocating step, when a number of connections by the radio terminal to the radio base station is less than a predetermined value, the radio base station allocates more than one of the uplink control channel elements to the radio terminal.

According to the radio communication system of the present invention, the transmission quality of control information can be improved.

### BRIEF DESCRIPTION OF DRAWINGS

The present invention will be further described below with reference to the accompanying drawings, wherein:

FIG. 1 is a block diagram of a radio communication system according to an embodiment of the present invention;

FIG. 2 is a flowchart of operations by the radio communication system according to an embodiment of the present invention;

FIG. 3 is a detailed view of resources in an uplink control channel according to an embodiment of the present invention;

FIG. 4 is a flowchart of operations by Modification 1 to the radio communication system according to an embodiment of the present invention;

FIG. 5 is a flowchart of operations by Modification 2 to the radio communication system according to an embodiment of the present invention;

FIG. 6 is a flowchart of operations by Modification 3 to the radio communication system according to an embodiment of the present invention; and

FIG. 7 is a detailed view of resources in an uplink control channel using a conventional technique.

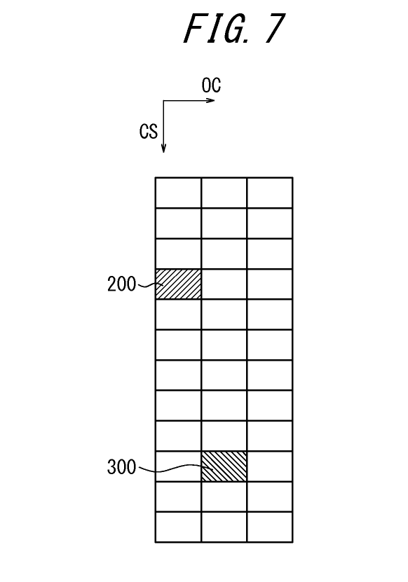

### DESCRIPTION OF EMBODIMENTS

The following describes an embodiment of the present invention.

### Embodiment

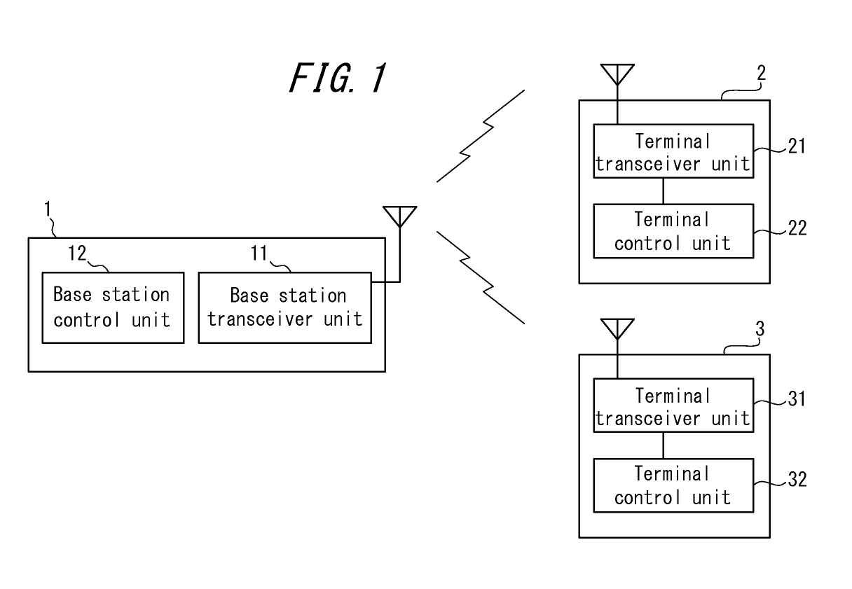

FIG. 1 is a block diagram of a radio communication system according to an embodiment of the present invention. A radio communication system according to an embodiment of the present invention includes a radio base station 1, a radio terminal 2 connected to the radio base station 1, and a radio terminal 3 connected to the radio base station 1. For the sake of explanation, two radio terminals are illustrated in FIG. 1, yet the number is not limited to two. The radio terminal 2 alone may be included, or three or more radio terminals may exist.

The radio base station 1 includes a base station transceiver unit 11 and a base station control unit 12. In accordance with LTE specifications, the base station transceiver unit 11 transmits signals to and receives signals from the radio terminal 2 and the radio terminal 3 by radio. In greater detail, the base station transceiver unit 11 receives radio signals and control information from the radio terminal 2 and transmits the address of each uplink control channel element for the radio terminal 2 to the radio terminal 2. The base station transceiver unit 11 similarly transmits signals to and receives signals from the radio terminal 3.

The base station control unit 12 executes a variety of control related to the radio base station 1. In greater detail, the base station control unit 12 determines whether the quality of the radio signal received by the base station transceiver unit 11 is less than a first threshold. The quality of the radio signal is, for example, estimated using the value of the Received Signal Strength Indication (RSSI) or the Signal to Interference and Noise power Ratio (SINR). For example, the first threshold is set to −80 dbm for RSSI. The base station control unit 12 also determines whether the number of connections by a radio terminal connected to the radio base station 1 is less than a predetermined value. For example, the predetermined value is set to 18. The base station control unit 12 also executes control to allocate a plurality of uplink control channels to the radio terminal 2 and the radio terminal 3.

The radio terminal 2 includes a terminal transceiver unit 21 and a terminal control unit 22. In accordance with LTE specifications, the terminal transceiver unit 21 transmits signals to and receives signals from the radio base station 1 by radio. In greater detail, the terminal transceiver unit 21 transmits radio signals and control information and receives the address of each uplink control channel element for the radio terminal 2. The terminal transceiver unit 21 transmits the control information based on the address of each uplink control channel element as received from the radio base station 1.

The terminal control unit 22 executes control related to the radio terminal 2. In greater detail, based on the received address of each uplink control channel element, the terminal control unit 22 executes control so that control information related to the radio terminal 2 is transmitted over a plurality of uplink control channel elements. Note that the terminal control unit 22 stores identical control information in the plurality of uplink control channel elements. As described below, the terminal control unit 22 may also store different control information in the plurality of uplink control channel elements.

The radio terminal 3 includes a terminal transceiver unit 31 and a terminal control unit 32. The terminal transceiver unit 31 and the terminal control unit 32 respectively correspond to the terminal transceiver unit 21 and the terminal control unit 22 in the radio terminal 2 and have the same functions.

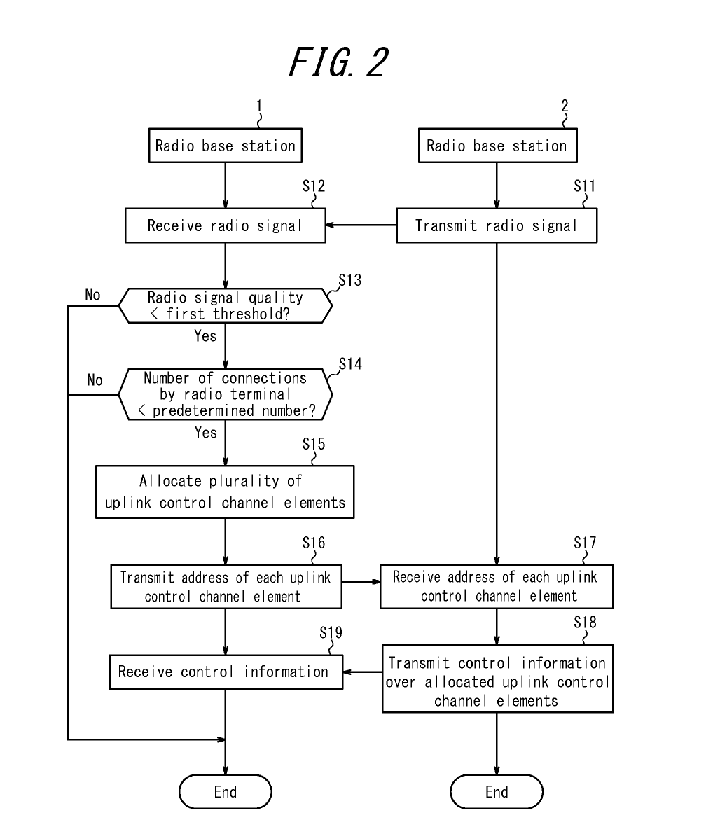

Next, the operations of the radio communication system according to the present invention are described with reference to the flowchart in FIG. 2.

First, the terminal transceiver unit 21 of the radio terminal 2 transmits a radio signal to the radio base station 1 in accordance with LTE specifications (step S11). The base station transceiver unit 11 of the radio base station 1 receives the radio signal (step S12).

Next, the base station control unit 12 of the radio base station 1 determines whether the quality of the radio signal received by the base station transceiver unit 11 is less than a first threshold (step S13). As a result of the determination, if the quality of the radio signal is less than the first threshold, processing proceeds to step S14. Conversely, if the quality of the radio signal is equal to or greater than the first threshold as a result of the determination, processing terminates.

As a result of the determination, when the quality of the radio signal is less than the first threshold, the base station control unit 12 determines whether the number of connections by a radio terminal connected to the radio base station 1 is less than a predetermined value (step S14). As a result of the determination, if the number of connections by a radio terminal is less than the predetermined value, processing proceeds to step S15. Conversely, if the number of connections by a radio terminal is equal to or greater than the predetermined value as a result of the determination, processing terminates.

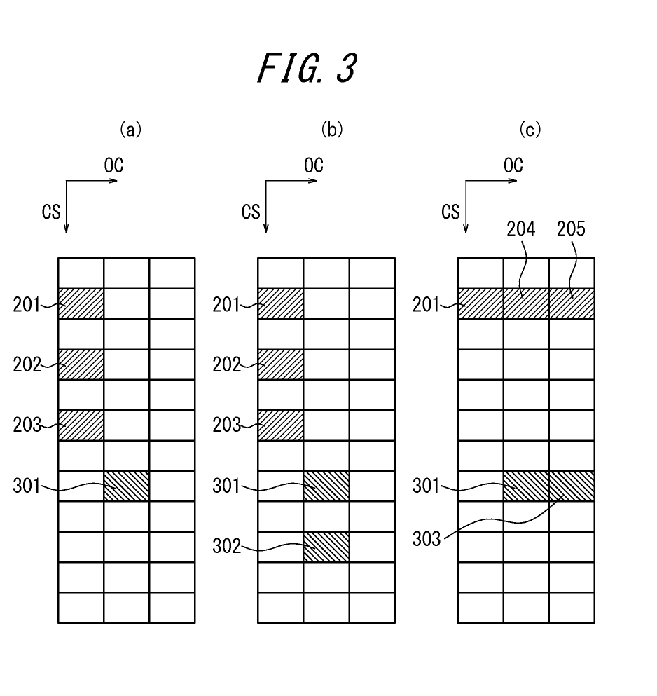

As a result of the determination, when the number of connections by a radio terminal is less than the predetermined value, the base station control unit 12 allocates a plurality (i.e. more than one) of the uplink control channel elements to the radio terminal 2 (step S15). FIG. 3 is a detailed view of resources allocated by the base station control unit 12 at this point in the uplink control channel.

FIG. 3(a) illustrates an example of a detailed view of resources within the uplink control channel. Uplink control channel elements 201 to 203 are allocated to the radio terminal 2, and uplink control channel element 301 is allocated to the radio terminal 3. In the address of the uplink control channel elements 201 to 203, the OC is the same, whereas the CS differs for each one. The uplink control channel elements 201 to 203 are each separated by an interval of one uplink control channel element. This is to improve delay tolerance of signals by providing a constant interval between the uplink control channel elements 201 to 203. This interval is set as needed and may also be a constant interval of two or more uplink control channel elements. Alternatively, the CS of allocated uplink control channel elements may be continuous, without providing an interval.

The base station control unit 12 thus allocates the uplink control channel elements 201 to 203 to the radio terminal 2. In FIG. 3(a), a total of three uplink control channel elements are allocated to the radio terminal 2, yet the allocated number is not limited to three. Instead, the number may be two, or it may be four or more.

FIG. 3(b) illustrates another example of a detailed view of resources within the uplink control channel. In general, FIG. 3(b) illustrates a plurality of uplink control channel elements being allocated to the radio terminal 3 as well. In FIG. 3(b), the same reference signs are used for the same portions as in FIG. 3(a), and a description thereof is omitted. In FIG. 3(b), uplink control channel element 302 is additionally allocated to the radio terminal 3.

FIG. 3(c) illustrates yet another example of a detailed view of resources within the uplink control channel. In general, FIG. 3(c) illustrates a plurality of uplink control channel elements with the same CS and different OCs being allocated to radio terminals. In FIG. 3(c), the same reference signs are used for the same portions as in FIG. 3(a), and a description thereof is omitted. In FIG. 3(c), the uplink control channel element 201, uplink control channel element 204, and uplink control channel element 205 are allocated to the radio terminal 2, and the uplink control channel element 301 and uplink control channel element 303 are allocated to the radio terminal 3. In the address of the uplink control channel element 201, the address of the uplink control channel element 204, and the address of the uplink control channel element 205, the CS is the same, whereas the OC differs. Similarly, in the address of the uplink control channel element 301 and the address of the uplink control channel element 303, the CS is the same, whereas the OC differs.

The base station transceiver unit 11 then transmits, to the radio terminal 2, the address of each uplink control channel element allocated to the radio terminal 2 (step S16). In other words, in step S15, since the base station control unit 12 allocated the uplink control channel elements 201 to 203 to the radio terminal 2, the base station transceiver unit 11 transmits the address of these control channel elements 201 to 203 to the radio terminal 2. The terminal transceiver unit 21 of the radio terminal 2 receives the address of each uplink control channel element (step S17).

Based on the received address of each uplink control channel element, the terminal control unit 22 of the radio terminal 2 then executes control so that control information related to the radio terminal 2 is transmitted over a plurality of uplink control channel elements. Based on this control, the terminal transceiver unit 21 transmits the control information related to the radio terminal 2 to the radio base station 1 (step S18). The base station transceiver unit 11 of the radio base station 1 receives the control signal (step S19) and acquires the control information by decoding the control information. Processing then terminates.

The terminal control unit 22 stores identical control information in the uplink control channel elements 201 to 203. By storing the control information in this way, the base station control unit 12 can combine the control information extracted from the control channel signal in the uplink control channel elements 201 to 203 and perform error correction on the control information, thereby acquiring more accurate control information.

In this way, according to the present invention, in step S14 the base station control unit 12 compares the number of radio terminals connected to the radio base station 1 with the number of uplink control channel elements, and when the number of radio terminals is smaller, allocates a plurality of uplink control channel elements to a radio terminal, thereby utilizing the uplink control channel elements. By, for example, combining control information stored in a plurality of uplink control channel elements, the transmission quality of the control information can therefore be improved.

Furthermore, according to the present invention, since the radio signal quality from the radio terminal 2 being less than the first threshold in step S13 is a condition for allocating a plurality of the uplink control channel elements, then when the radio signal quality is poor, the base station control unit 12 allocates a plurality of the uplink control channel elements to the radio terminal. By combining, for example, the plurality of allocated uplink control channel elements, the transmission quality of the control information can be improved.

Instead of identical control information, the terminal control unit 22 may store different control information in the uplink control channel elements 201 to 203. For example, the terminal control unit 22 may store scheduling request information in the uplink control channel element 201, HARQ ACK/NACK information for code word 1 in the uplink control channel element 202, and HARQ ACK/NACK information for code word 2 in the uplink control channel element 203. In this way, the amount of information (number of bits) that can be allocated to each set of control information can be increased, and the base station control unit 12 can acquire more accurate control information.

Note that the order of steps S13 and S14 may be reversed. In other words, before determining the quality of the radio signal, the number of connections by a radio terminal connected to the radio base station 1 may be determined.

The base station control unit 12 need not perform the determination in step S13. In this case, based only on the determination in step S14, the base station control unit 12 can control whether to allocate a plurality of the uplink control channel elements.

In the present embodiment, an example has been described of transmitting over the uplink control channel in “format 1”, yet the present invention is not limited to “format 1” and may similarly be applied when transmitting over the uplink control channel in “format 2”.

Modification 1

Next, Modification 1 to an embodiment of the present invention is illustrated. Overall, in the radio communication system illustrated in Modification 1, based on the quality of a radio signal transmitted by the radio base station 1, the radio terminal 2 issues a request to the radio base station 1 for allocation of a plurality of uplink control channel elements, and the radio base station 1 allocates a plurality of uplink control channel elements to the radio terminal 2.

The structure of the radio communication system in Modification 1 is the same as the structure illustrated in FIG. 1. However, the terminal control unit 22 in Modification 1 also executes control to generate an allocation request to increase the number of uplink control channel elements allocated to the radio terminal 2 to more than one. The terminal transceiver unit 21 in Modification 1 also transmits the allocation request to the radio base station 1.

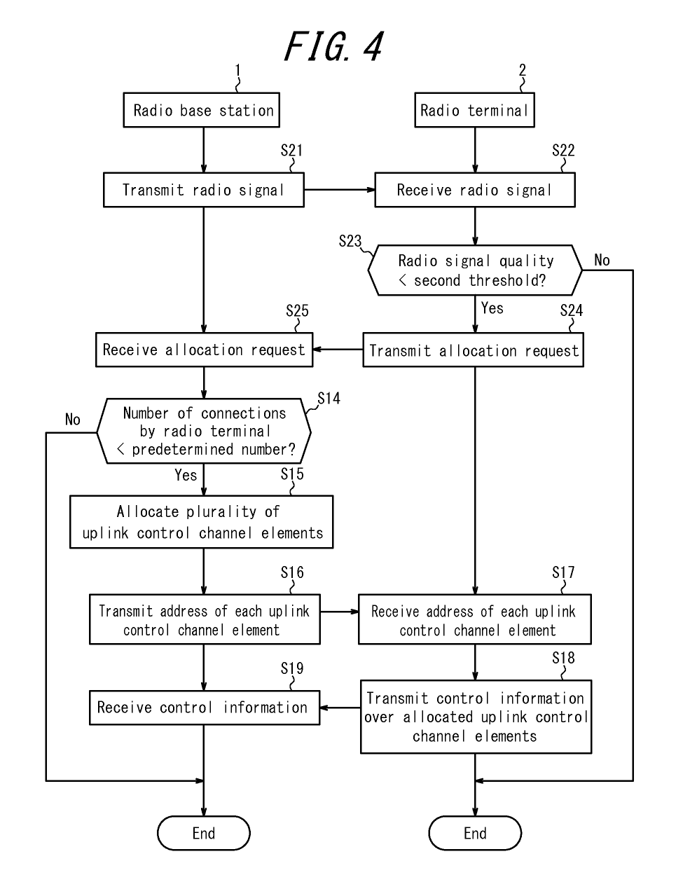

FIG. 4 is a flowchart of operations by Modification 1 to the radio communication system according to the present invention. In FIG. 4, the same reference signs are used for operations that are the same as those illustrated in FIG. 3, and a description thereof is omitted.

First, the base station transceiver unit 11 of the radio base station 1 transmits a radio signal to the radio terminal 2 (step S21). The terminal transceiver unit 21 of the radio terminal 2 receives the radio signal (step S22).

Next, the terminal control unit 22 of the radio terminal 2 determines whether the quality of the radio signal received by the terminal transceiver unit 21 is less than a second threshold (step S23). The quality of the radio signal is, for example, estimated using the signal level. For example, the second threshold is set to −80 dbm for RSSI. As a result of the determination, if the quality of the radio signal is less than the second threshold, processing proceeds to step S24. Conversely, if the quality of the radio signal is equal to or greater than the second threshold as a result of the determination, processing terminates.

As a result of the determination, if the quality of the radio signal is less than the second threshold, the terminal control unit 22 executes control to generate an allocation request to increase the number of uplink control channel elements allocated to the radio terminal 2 to more than one. The terminal transceiver unit 21 of the radio terminal 2 transmits the allocation request to the radio base station 1 (step S24). The base station transceiver unit 11 of the radio base station 1 receives the allocation request (step S25).

The base station control unit 12 of the radio base station 1 then determines the number of terminals connected to the radio base station 1. Subsequent operations in steps S14 through S19 are the same as those in FIG. 3.

In this way, according to the radio communication system of Modification 1, the terminal transceiver unit 21 of the radio terminal 2 itself issues an allocation request to increase the uplink control channel elements in accordance with the radio signal quality of the radio signal received from the radio base station 1. Therefore, by allocating a plurality of uplink control channel elements to the radio terminal when the radio signal quality is poor and combining, for example, the allocated plurality of uplink control channel elements, the transmission quality of the control information can be improved.

Note that step S11 to step S13 in FIG. 2, i.e. operations to determine the quality of the radio signal transmitted by the radio terminal 2, may be included between step S25 and step S14. In this case, the quality of the radio signal transmitted by the radio terminal 2 being less than the first threshold is added as a condition for allocating a plurality of uplink control channel elements.

Modification 2

Next, Modification 2 to an embodiment of the present invention is illustrated. Overall, in the radio communication system illustrated in Modification 2, based on the Aggregation Level (referred to below as AL) of the control information transmitted over the Physical Downlink Control Channel (PDCCH), the radio terminal 2 issues a request to the radio base station 1 for allocation of a plurality of uplink control channel elements, and the radio base station 1 allocates a plurality of uplink control channel elements to the radio terminal 2.

The structure of the radio communication system in Modification 2 is the same as the structure illustrated in FIG. 1. However, the terminal control unit 22 in Modification 2 also acquires the AL allocated to the radio terminal 2 based on the control information received by the terminal transceiver unit 21. When the AL is two or more, the terminal control unit 22 also executes control to generate an allocation request to increase the number of uplink control channel elements allocated to the radio terminal 2 to more than one. The terminal transceiver unit 21 in Modification 2 also transmits the allocation request to the radio base station 1.

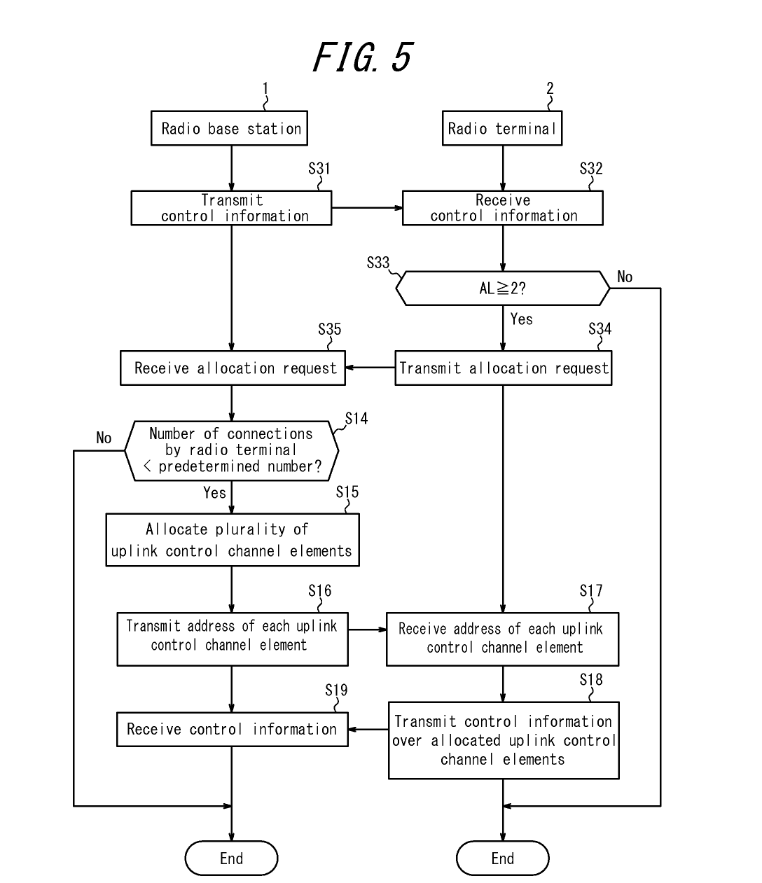

FIG. 5 is a flowchart of operations by Modification 2 to the radio communication system according to the present invention. In FIG. 5, the same reference signs are used for operations that are the same as those illustrated in FIG. 3, and a description thereof is omitted.

First, the base station transceiver unit 11 of the radio base station 1 transmits control information over a downlink control channel to the radio terminal 2 (step S31). The terminal transceiver unit 21 of the radio terminal 2 receives the control information (step S32).

Next, the terminal control unit 22 of the radio terminal 2 acquires the AL allocated to the radio terminal 2 based on the control information received by the terminal transceiver unit 21. The AL is the number of Control Channel Elements (CCE) allocated to the radio terminal 2 in the downlink control channel, and therefore the terminal control unit 22 acquires the AL by decoding the downlink control channel. The terminal control unit 22 then determines whether the AL is two or more (step S33). As a result of the determination, if the AL is two or more, processing proceeds to step S24. Conversely, if the AL is less than two as a result of the determination, processing terminates. Note that the AL takes one of the following values: 1, 2, 4, or 8. Accordingly, when the AL is one, processing terminates.

As a result of the determination, when the AL is two or more, the terminal control unit 22 executes control to generate an allocation request to increase the number of uplink control channel elements allocated to the radio terminal 2 to more than one. The number of control channel elements in the allocation request is the same as the value of the AL. In other words, if the AL is two, four, or eight, then the number of control channel elements in the allocation request is respectively two, four, or eight. The terminal transceiver unit 21 of the radio terminal 2 transmits the allocation request to the radio base station 1 (step S34). The base station transceiver unit 11 of the radio base station 1 receives the allocation request (step S35).

The base station control unit 12 of the radio base station 1 then determines the number of terminals connected to the radio base station 1. Subsequent operations in steps S14 through S19 are the same as those in FIG. 3.

In this way, according to the radio communication system of Modification 2, the radio terminal 2 itself issues an allocation request to increase the uplink control channel elements in accordance with the AL of the radio terminal 2. Therefore, by allocating a plurality of uplink control channel elements to a radio terminal for which the AL is two or more, i.e. a radio terminal in a poor transmission environment, and combining, for example, the allocated plurality of uplink control channel elements, the transmission quality of the control information can be improved.

While the value of the AL and the requested number of allocated uplink control channel elements are described as being the same, Modification 2 is not limited to this case. For example, when the value of the AL is two, the requested number of allocated uplink control channel elements may be two, and when the value of the AL is four, the requested number of allocated uplink control channel elements may be increased by one in comparison with when the value of the AL is two, i.e. increased to three. When the value of the AL is eight, the requested number of allocated uplink control channel elements may be increased again by one to yield four. The requested number of allocated elements may be modified in this way as necessary.

Note that step S11 to step S13 in FIG. 2, i.e. operations to determine the quality of the radio signal transmitted by the radio terminal 2, may be included between step S35 and step S14. In this case, the quality of the radio signal transmitted by the radio terminal 2 being less than the first threshold is added as a condition for allocating a plurality of uplink control channel elements.

Modification 3

Next, Modification 3 to an embodiment of the present invention is illustrated. In the radio communication system illustrated in Modification 3, before the radio terminal 2 performs radio communication with the radio base station 1, the radio base station 1 allocates the control channel element that will serve as a standard when transmitting control information. When the value of the AL of the control information transmitted over the downlink control channel is two or more, the radio terminal 2 transmits the control information over a plurality of continuous uplink control channel elements equal in number to the value of the AL, starting at the standard control channel element. Note that the plurality of continuous uplink control channel elements refers to a plurality of continuous uplink control channel elements for which the CS is the same and the OC differs, or a plurality of continuous uplink control channel elements for which the OC is the same and the CS differs.

The structure of the radio communication system in Modification 3 is the same as the structure illustrated in FIG. 1. However, the terminal control unit 22 in Modification 3 also acquires the AL allocated to the radio terminal 2 based on the control information received by the terminal transceiver unit 21. When the value of the AL is two or more, the terminal control unit 22 also executes control so that the terminal transceiver unit 21 transmits the control information over a plurality of continuous uplink control channel elements equal in number to the value of the AL, starting at the standard control channel element.

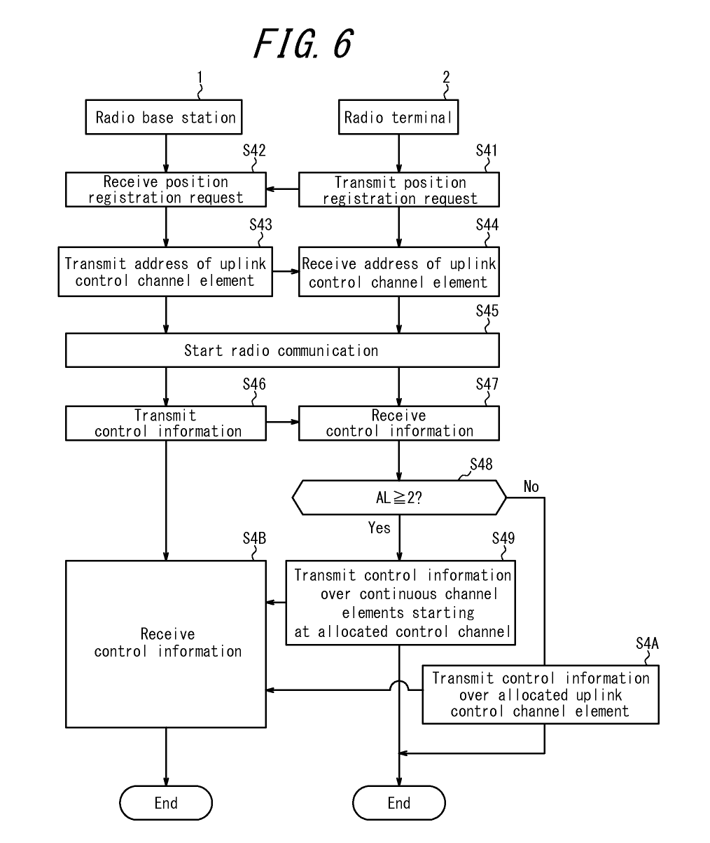

FIG. 6 is a flowchart of operations by Modification 3 to the radio communication system according to the present invention. First, the terminal transceiver unit 21 of the radio terminal 2 transmits a position registration request, for example, to the radio base station 1 (step S41). Upon the base station transceiver unit 11 of the radio base station 1 receiving the position registration request (step S42), the base station control unit 12 performs the position registration, allocates an uplink control channel element that will serve as a standard to the radio terminal 2, and transmits the address of the allocated uplink control channel element to the radio terminal 2 (step S43). The terminal transceiver unit 21 of the radio terminal 2 receives the address of the uplink control channel element (step S44). Subsequently, the radio terminal 2 issues a connection request to the radio base station 1 and begins radio communication (step S45).

The base station transceiver unit 11 of the radio base station 1 transmits control information over a downlink control channel to the radio terminal 2 (step S46). The terminal transceiver unit 21 of the radio terminal 2 receives the control information (step S47).

Next, the terminal control unit 22 of the radio terminal 2 acquires the AL allocated to the radio terminal 2 based on the control information received by the terminal transceiver unit 21. The terminal control unit 22 then determines whether the AL is two or more (step S48). As a result of the determination, if the AL is two or more, processing proceeds to step S49. Conversely, if the AL is less than two as a result of the determination, processing proceeds to step S4A.

In step S49, the terminal control unit 22 of the radio terminal 2 executes control so that the terminal transceiver unit 21 transmits the control information over a plurality of continuous uplink control channel elements equal in number to the value of the AL, starting at the standard control channel element. Based on this control, the terminal transceiver unit 21 transmits the control information related to the radio terminal 2 to the radio base station 1, and the base station transceiver unit 11 of the radio base station 1 receives the control information (step S4B).

On the other hand, in step S4A, the terminal control unit 22 of the radio terminal 2 executes control so that the terminal transceiver unit 21 transmits the control information over the standard control channel element allocated in advance. Based on this control, the terminal transceiver unit 21 transmits the control information related to the radio terminal 2 to the radio base station 1, and the base station transceiver unit 11 of the radio base station 1 receives the control information (step S4B).

Although the present invention has been described by way of an embodiment with reference to the accompanying drawings, it is to be noted that various changes and modifications will be apparent to those skilled in the art. Therefore, such changes and modifications are to be understood as included within the scope of the present invention. For example, the functions and the like included in the various members, units, steps, and the like may be reordered in any logically consistent way. Furthermore, units, steps, and the like may be combined into one or divided.

### REFERENCE SIGNS LIST

1: Radio base station
2, 3: Radio terminal
11: Base station transceiver unit
12: Base station control unit
21, 31: Terminal transceiver unit
22, 32: Terminal control unit

1. A radio communication system comprising a radio base station and a radio terminal,
the radio base station comprising:
a base station transceiver unit configured to receive a radio signal; and
a base station control unit configured to allocate any of a plurality of uplink control channel elements included in an uplink control channel to the radio terminal, wherein
when a number of connections by the radio terminal to the radio base station is less than a predetermined value, the base station control unit allocates more than one of the uplink control channel elements to the radio terminal.

2. The radio communication system according to claim 1, wherein the base station control unit acquires a reception quality of the radio terminal, and when the reception quality is less than a first threshold, allocates more than one of the uplink control channel elements to the radio terminal.

3. The radio communication system according to claim 1, wherein the radio terminal comprises:
a terminal transceiver unit configured to receive a radio signal; and
a terminal control unit configured to execute control so as to transmit control information over each uplink control channel element allocated based on an instruction from the radio base station.

4. The radio communication system according to claim 3, wherein when a reception quality of a radio signal transmitted by the radio base station is a second threshold or less, the terminal control unit issues a request to the radio base station for allocation of more than one of the uplink control channel elements.

5. The radio communication system according to claim 1, wherein the radio terminal transmits identical control information over the more than one uplink control channel elements.

6. The radio communication system according to claim 1, wherein the radio terminal transmits different control information over the more than one uplink control channel elements.

7. A radio base station comprising:
a base station transceiver unit configured to receive a radio signal; and
a base station control unit configured to allocate any of a plurality of uplink control channel elements included in an uplink control channel to a radio terminal, wherein
when a number of connections by the radio terminal to the radio base station is less than a predetermined value, the base station control unit allocates more than one of the uplink control channel elements to the radio terminal.

8. A method for radio communication comprising a radio base station and a radio terminal, the method comprising:
receiving, by the radio base station, a radio signal from the radio terminal; and
allocating, by the radio base station, any of a plurality of uplink control channel elements included in an uplink control channel to the radio terminal, wherein
in the allocating step, when a number of connections by the radio terminal to the radio base station is less than a predetermined value, the radio base station allocates more than one of the uplink control channel elements to the radio terminal.
